(19) United States
(12) Patent Application Publication
(10) Pub. No.: US 2022/0071446 A1
(43) Pub. Date: Mar. 10, 2022

(54) DOOR-LIFTING TYPE BARBECUE STOVE FOR GRILLING AND SMOKING

(71) Applicant: CHIA MING LIU, Douliu City (TW)

(72) Inventor: CHIA MING LIU, Douliu City (TW)

(21) Appl. No.: 17/070,541

(22) Filed: Oct. 14, 2020

(30) Foreign Application Priority Data
Sep. 8, 2020 (CN) 202021940505.3

(51) Int. Cl. A47J 37/07; A47J 36/12

(52) U.S. Cl. CPC A47J 37/0786; A23B 4/052; A47J 36/12

(57) ABSTRACT

A door-lifting type barbecue stove for grilling and smoking includes a furnace, a mounting rack, a door assembly, and a linkage mechanism. The mounting rack is fixed on the furnace and is disposed above the furnace. The door assembly is disposed above the furnace, is adjacent to the mounting rack, and swings relative to the mounting rack and the furnace. The linkage mechanism connects the mounting rack and the door assembly, lifts the door assembly up, and makes the door assembly swing relative to the mounting rack.

### BACKGROUND OF THE INVENTION

### 1. Field of the Invention

The present invention relates to a barbecue stove, and more particularly to a door-lifting type barbecue stove for grilling and smoking.

### 2. Description of Related Art

To enable a user to cook food by both grilling and smoking using the same stove, a conventional lifting type barbecue stove includes a stove, a guiding device, and a lid. The stove is disposed at a lower half part of the conventional lifting type barbecue stove. The guiding device is disposed on the stove. The lid is mounted to the guiding device and is moveable along the guiding device vertically. In such a configuration, the lid can cover the stove or elevate to a position away from the stove. In the state that the lid covers the stove, an interior of the conventional lifting type barbecue stove does not communicate with an exterior of the conventional lifting type barbecue stove, so the user can cook the food by smoking. In the state that the lid elevates to the position away from the stove, the interior of the conventional lifting type barbecue stove communicates with the exterior of the conventional lifting type barbecue stove, so the user can cook the food by grilling.

Although the conventional lifting type barbecue stove can be used in both a closed state and an open state with the lid moving along the guiding device vertically to enable the user to cook the food in different ways, the increased height of the lid during the elevation of the lid relative to the stove causes the elevation of the center of gravity of the conventional lifting type barbecue stove. When the center of gravity of the conventional lifting type barbecue stove elevates, the conventional lifting type barbecue stove tends to tip over, which may injure the user or even cause the outbreak of fire. Consequently, the conventional lifting type barbecue stove does not pass the safety test.

To overcome the shortcomings of the conventional lifting type barbecue stove, the present invention tends to provide a door-lifting type barbecue stove for grilling and smoking to mitigate or obviate the aforementioned problems.

### SUMMARY OF THE INVENTION

The main objective of the present invention is to provide a door-lifting type barbecue stove for grilling and smoking.

The door-lifting type barbecue stove for grilling and smoking includes a furnace, a mounting rack, a door assembly, and a linkage mechanism. The mounting rack is fixed on the furnace and is disposed above the furnace. The door assembly is disposed above the furnace, is adjacent to the mounting rack, and swings relative to the mounting rack and the furnace. The linkage mechanism connects the mounting rack and the door assembly, lifts the door assembly up, and makes the door assembly swing relative to the mounting rack.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a door-lifting type barbecue stove for grilling and smoking in accordance with the present invention;

FIG. 2 is an enlarged perspective view of the door-lifting type barbecue stove for grilling and smoking in FIG. 1;

FIG. 3 is a perspective view of a linkage mechanism of the door-lifting type barbecue stove for grilling and smoking in FIG. 1;

FIG. 4 is an enlarged operational perspective view of the door-lifting type barbecue stove for grilling and smoking in FIG. 1;

FIG. 5 is an operational perspective view of the linkage mechanism of the door-lifting type barbecue stove for grilling and smoking in FIG. 1; and

FIGS. 6 to 8 are enlarged operational side views of the door-lifting type barbecue stove for grilling and smoking in FIG. 1.

### DETAILED DESCRIPTION OF THE PREFERRED EMBODIMENT

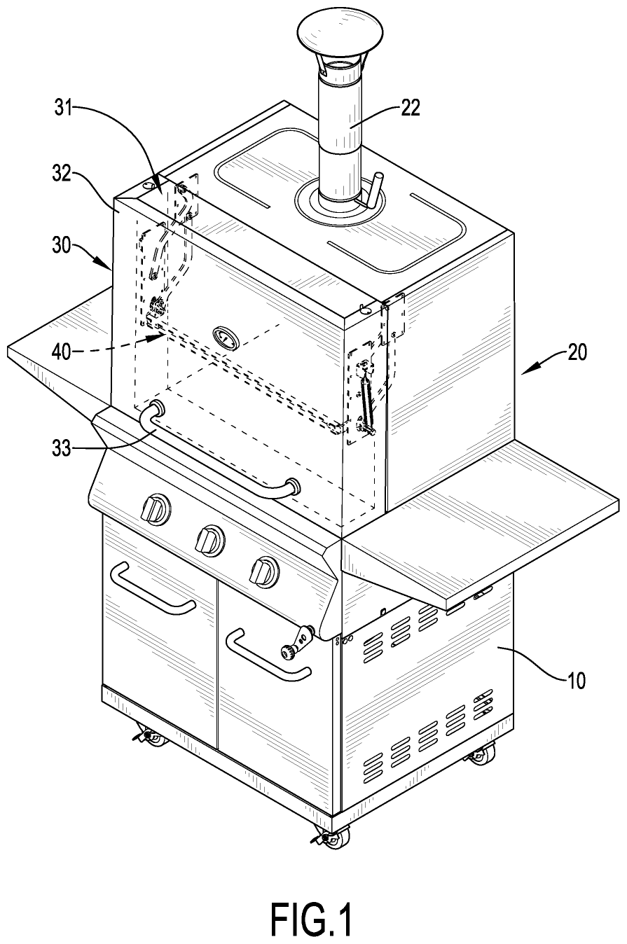

With reference to FIGS. 1 to 3, a door-lifting type barbecue stove for grilling and smoking in accordance with the present invention includes a furnace 10, a mounting rack 20, a door assembly 30, and a linkage mechanism 40.

With reference to FIG. 1, the furnace 10 is disposed at a lower half part of the door-lifting type barbecue stove.

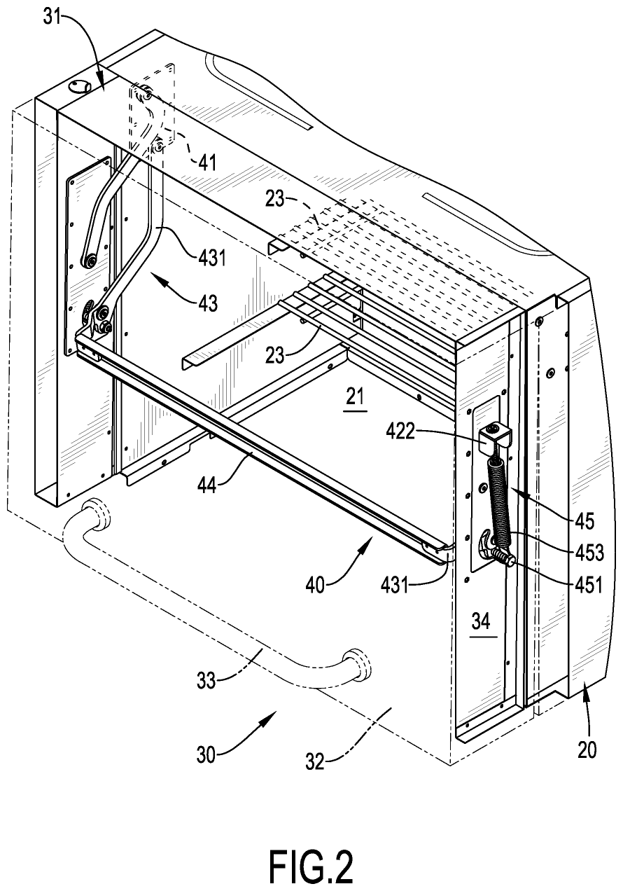

With reference to FIGS. 1 and 2, the mounting rack 20 is fixed on the furnace 10, is disposed above the furnace 10, and has a containing space 21, an exhaust pipe 22, and multiple cooking grate sets 23. The containing space 21 is formed within the mounting rack 20. The exhaust pipe 22 is disposed on a top of the mounting rack 20 and communicates with the containing space 21. Each one of the multiple cooking grate sets 23 is mounted to two opposite inner side surfaces of the mounting rack 20, and the multiple cooking grate sets 23 are arranged at spaced intervals vertically.

With reference to FIGS. 1, 2, and 4, the door assembly 30 is disposed above the furnace 10, is adjacent to the mounting rack 20, and swings relative to the mounting rack 20 and the furnace 10. The door assembly 30 has a body 31, a casing 32, and a handle 33. The body 31 is adjacent to the mounting rack 20 and swings relative to the mounting rack 20 and the furnace 10. The casing 32 covers the body 31 and has two sidewalls. Each one of the two sidewalls of the casing 32 is spaced apart from a respective one of two sidewalls of the body 31, such that each one of the two sidewalls of the casing 32 forms a receiving space 34 with the corresponding sidewall of the body 31. The handle 33 has two ends disposed through the casing 32 and mounted to the body 31.

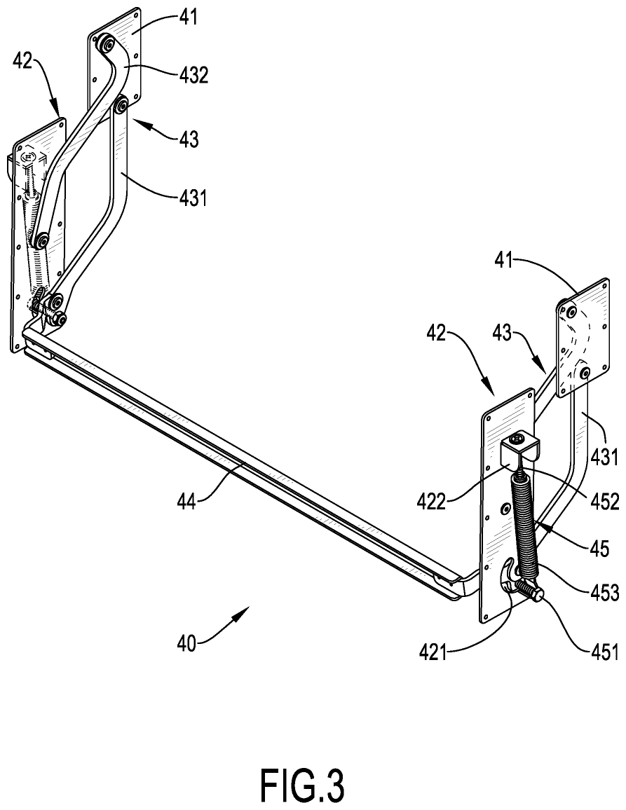

With reference to FIGS. 2 and 3, the linkage mechanism 40 connects the mounting rack 20 and the door assembly 30, lifts the door assembly 30 up and makes the door assembly 30 swing relative to the mounting rack 20, and has two fixing plates 41, two positioning plates 42, two linkage assemblies 43, a connecting rod 44, and two buffering assemblies 45. The two fixing plates 41 are respectively mounted to the two inner side surfaces of the mounting rack 20 and are disposed in the containing space 21 of the mounting rack 20. The two positioning plates 42 are respectively mounted to two inner side surfaces of the body 31 of the door assembly 30, and each one of the two positioning plates 42 has a guiding groove 421 and a connecting portion 422. The guiding groove 421 is disposed through the positioning plate 42, is arched, and has a notch facing the mounting rack 20. The connecting portion 422 protrudes from one of two side surfaces of the positioning plate 42 away from the other one of the two positioning plates 42 and is disposed in one of the two receiving spaces 34 formed by one of the two sidewalls of the body 31 to which the positioning plate 42 is attached and the corresponding sidewall of the casing 32. Furthermore, the two positioning plates 42 are disposed symmetrically.

With reference to FIGS. 2 and 3, the two linkage assemblies 43 are disposed symmetrically, and each one of the two linkage assemblies 43 is mounted to a respective one of the two fixing plates 41 and a respective one of the two positioning plates 42. Each one of the two linkage assemblies 43 has a first linkage arm 431 and a second linkage arm 432. The first linkage arm 431 has two ends. One of the two ends of the first linkage arm 431 is pivotally mounted to the corresponding fixing plate 41, and the other one of the two ends of the first linkage arm 431 is pivotally mounted to the corresponding positioning plate 42. The second linkage arm 432 is disposed above the first linkage arm 431 and has two ends. One of the two ends of the second linkage arm 432 is pivotally mounted to the corresponding fixing plate 41, and the other one of the two ends of the second linkage arm 432 is pivotally mounted to the corresponding positioning plate 42.

With reference to FIGS. 2 and 3, the connecting rod 44 has two ends respectively mounted to the two first linkage arms 431 of the two linkage assemblies 43, such that the two linkage assemblies 43 move simultaneously. Each one of the two buffering assemblies 45 is mounted to the first linkage arm 431 of one of the two linkage assemblies 43 and one of the two positioning plates 42 to which the first linkage arm 431 is mounted, and each one of the two buffering assemblies 45 has a guiding element 451, a positioning element 452, and an elastic set 453. The guiding element 451 is mounted to the first linkage arm 431, passes through the guiding groove 421 of the positioning plate 42, and extends into the corresponding receiving space 34. The positioning element 452 is mounted to the connecting portion 422 of the positioning plate 42 and is capable of moving relative to the connecting portion 422. The elastic set 453 has two ends. One of the two ends of the elastic set 453 is mounted to the guiding element 451, and the other one of the two ends of the elastic set 453 is mounted to the positioning element 452.

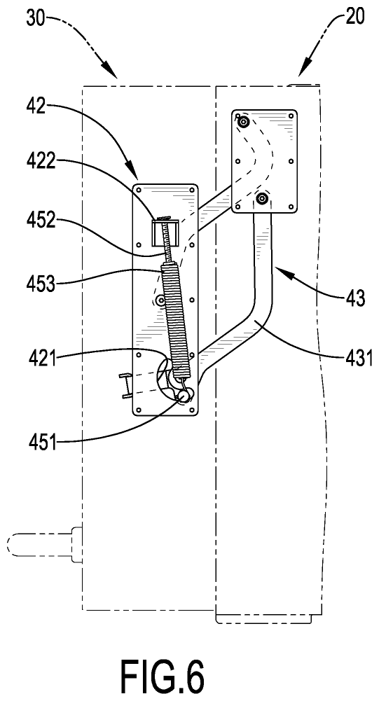

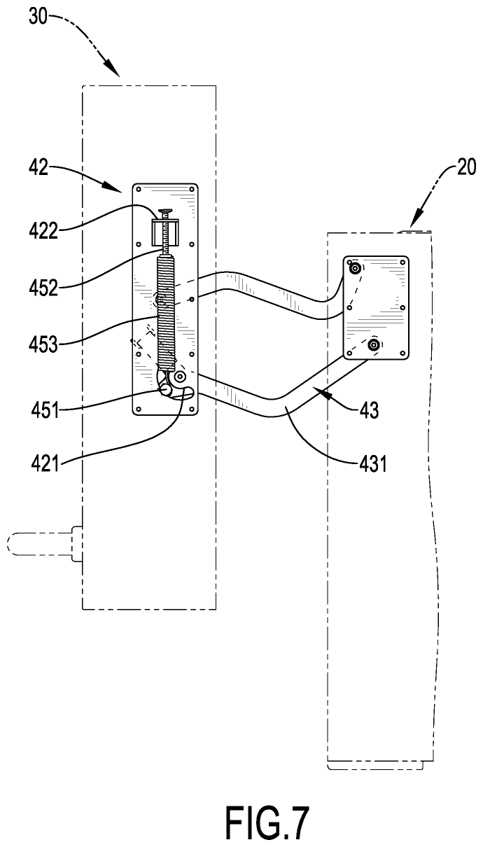

With reference to FIGS. 1 to 3, when the door assembly 30 is not lifted up, a space formed between the door assembly 30, the mounting rack 20, and the furnace 10 communicates with an exterior of the present invention merely via the exhaust pipe 22. In the state that the door assembly 30 is closed, the food placed on each one of the multiple cooking grate sets 23 is smoked. When a user needs to take the food placed on each one of the multiple cooking grate sets 23 out of the door-lifting type barbecue stove or when the user wants to grill the food, the user can hold the handle 33 and lift the handle 33 upwardly. Then the door assembly 30 is lifted upwardly and elevates relative to the furnace 10. Since the door assembly 30 and the mounting rack 20 are connected by the linkage mechanism 40, the door assembly 30 elevates and swings relative to the mounting rack 20 as shown in FIGS. 6 to 8. In the process of the elevation of the door assembly 30, the door assembly 30 elevates and moves away from the mounting rack 20 as shown in FIGS. 6 and 7.

Simultaneously, the guiding element 451 of each one of the two buffering assemblies 45 moves in the corresponding guiding groove 421 to a position located between two ends of the guiding groove 421 from its original position, and the positioning element 452 of each one of the two buffering assemblies 45 is pushed by the corresponding guiding element 451 and the corresponding elastic set 453 and extends out of the connecting portion 422 of the corresponding positioning plate 42.

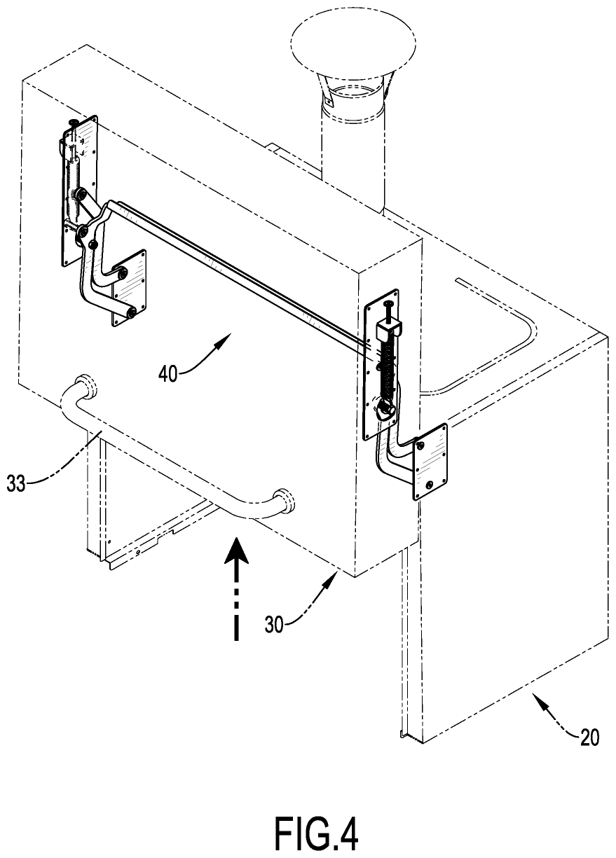

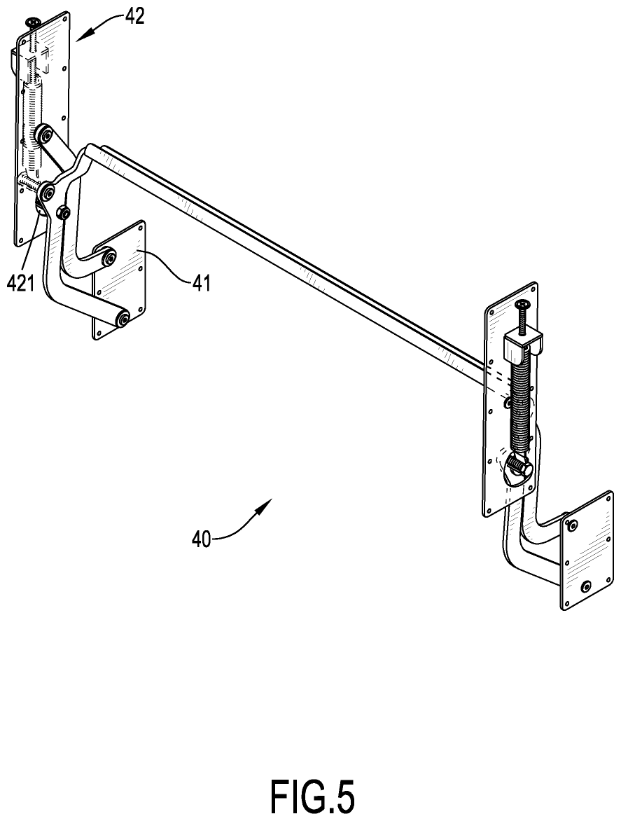

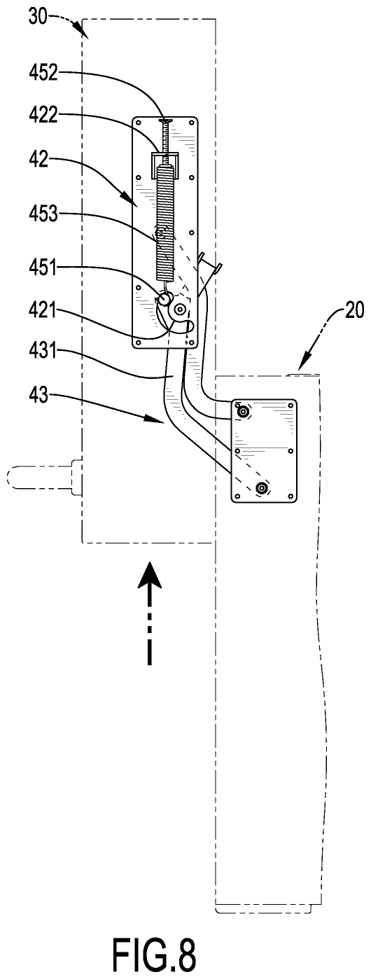

With reference to FIGS. 7 and 8, next, the door assembly 30 elevates and moves toward the mounting rack 20. Simultaneously, the guiding element 451 of each one of the two buffering assemblies 45 moves to one of the two ends of the corresponding guiding groove 421 away from its original position. The spatial relationship of the door assembly 30 and the linkage mechanism 40 is shown in FIGS. 4 and 5. At this time, the containing space 21 of the mounting rack 20 communicates with the exterior of the door-lifting type barbecue stove.

Because the linkage mechanism 40 has the two buffering assemblies 45, the elastic set 453 of each one of the two linkage assemblies 43 provides the door assembly 30 with a buffering effect during the process that the door assembly 30 is lifted up. With such a configuration, slamming of the door assembly 30 is avoided and the user can lift up the door assembly 30 in an effort-saving way.

With the aforementioned technical characteristics, the door-lifting type barbecue stove for grilling and smoking has the following advantages.

1. Compared with the conventional lifting type barbecue stove having the lid moveable along the guiding device vertically, the door assembly 30 of the door-lifting type barbecue stove is lifted up by the linkage mechanism 40 connecting the mounting rack 20 and the door assembly 30, so the door assembly 30 swings relative to the mounting rack 20 during the process of elevating. In the way that the door assembly 30 swings relative to the mounting rack 20 during the process of elevating, the increased height of the door assembly 30 is smaller than that of the lid of the conventional lifting type barbecue stove. Thus, when the door assembly 30 is lifted up, the center of gravity of the door-lifting type barbecue stove is lower than that of the lid of the conventional lifting type barbecue stove when the lid elevates. With such a configuration, the door-lifting type barbecue stove in accordance with the present invention does not tend to tilt over, so the safety of the user is ensured. Moreover, since the ratio of the weight of the door assembly 30 to the weight of the door assembly 30 and the mounting rack 20 is less than one half, the increased height of the center of gravity of the door-lifting type barbecue stove when the door assembly 30 is lifted up is limited, which lowers the probability of tilting over of the door-lifting type barbecue stove in accordance with the present invention.

2. Since the linkage mechanism 40 has the two buffering assemblies 45, the elastic set 453 of each one of the two linkage assemblies 43 provides the door assembly 30 with a buffering effect during the process that the door assembly 30 is lifted up. With such a configuration, the user can lift up the door assembly 30 in an effort-saving way and the safety of the user is improved.

3. The door assembly 30 can be lifted up by the linkage mechanism 40 with two steps. That is, the door assembly 30 can be in a position shown in FIG. 7 rather than being lifted up completely as shown in FIG. 8. In such a way, heat loss is reduced, and the cooking time is therefore reduced.

4. Because the multiple cooking grate sets 23 are arranged at spaced intervals vertically, the distances between each one of the multiple cooking grate sets 23 and the stove 10 are different. Thus, the degrees of doneness of food can be controlled by placing different food on different cooking grate sets 23.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A door-lifting type barbecue stove for grilling and smoking comprising:
a furnace;
a mounting rack fixed on the furnace and disposed above the furnace;
a door assembly disposed above the furnace, being adjacent to the mounting rack, and being swingable relative to the mounting rack and the furnace; and
a linkage mechanism connecting the mounting rack and the door assembly, lifting the door assembly up, and making the door assembly swing relative to the mounting rack.

2. The barbecue stove as claimed in claim 1, wherein the linkage mechanism has
at least one positioning plate mounted to one of two inner side surfaces of the door assembly; and
at least one linkage assembly having
a first linkage arm having two ends, one of the two ends of the first linkage arm pivotally mounted to the mounting rack, and the other one of the two ends of the first linkage arm pivotally mounted to the at least one positioning plate; and
a second linkage arm having two ends, one of the two ends of the second linkage arm pivotally mounted to the mounting rack, and the other one of the two ends of the second linkage arm pivotally mounted to the at least one positioning plate.

3. The barbecue stove as claimed in claim 2, wherein the linkage mechanism has
two said positioning plates disposed symmetrically; and
two said linkage assemblies disposed symmetrically.

4. The barbecue stove as claimed in claim 3, wherein the linkage mechanism has a connecting rod having two ends respectively mounted to the two first linkage arms of the two linkage assemblies.

5. The barbecue stove as claimed in claim 2, wherein
the at least one positioning plate has
a guiding groove disposed through the at least one positioning plate, being arched, and having a notch facing the mounting rack; and
a connecting portion protruding from the at least one positioning plate; and
the linkage mechanism has at least one buffering assembly having
a guiding element mounted to the first linkage arm and through the guiding groove of the at least one positioning plate;
a positioning element mounted to the connecting portion of the at least one positioning plate and capable of moving relative to the connecting portion of the at least one positioning plate; and
an elastic set having two ends, one of the two ends of the elastic set mounted to the guiding element, and the other one of the two ends of the elastic set mounted to the positioning element.

6. The barbecue stove as claimed in claim 1, wherein the mounting rack has multiple cooking grate sets arranged at spaced intervals vertically, and each one of the multiple cooking grate sets is mounted to two opposite inner side surfaces of the mounting rack.

7. The barbecue stove as claimed in claim 2, wherein the mounting rack has multiple cooking grate sets arranged at spaced intervals vertically, and each one of the multiple cooking grate sets is mounted to two opposite inner side surfaces of the mounting rack.

8. The barbecue stove as claimed in claim 3, wherein the mounting rack has multiple cooking grate sets arranged at spaced intervals vertically, and each one of the multiple cooking grate sets is mounted to two opposite inner side surfaces of the mounting rack.

9. The barbecue stove as claimed in claim 4, wherein the mounting rack has multiple cooking grate sets arranged at spaced intervals vertically, and each one of the multiple cooking grate sets is mounted to two opposite inner side surfaces of the mounting rack.

10. The barbecue stove as claimed in claim 5, wherein the mounting rack has multiple cooking grate sets arranged at spaced intervals vertically, and each one of the multiple cooking grate sets is mounted to two opposite inner side surfaces of the mounting rack.
